(19) United States
(12) Patent Application Publication
(10) Pub. No.: US 2005/0108260 A1
(43) Pub. Date: May 19, 2005

(54) Organizational usage document management system

(75) Inventors: John C. Wenn, Redondo Beach, CA (US); Daniel W. Manchala, Torrance, CA (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/868,155

(22) Filed: Jun. 15, 2004

Related U.S. Application Data
(60) Provisional application No. 60/520,686, filed on Nov. 17, 2003.

(51) Int. Cl. G06F 7/00

(52) U.S. Cl. 707/100

(57) ABSTRACT

A document repository management system for an institution having a defined organization has (a) a first database containing organizational chart information including information identifying individuals in the defined organization, (b) a second database containing accessible documents, (c) programs for controlling requested access to each document of the accessible documents in the second database, and (d) programs for mapping, to the organizational chart information of the first database, each requested access to each document of the accessible documents, thereby enabling efficient management of the document repository based on historical tracking of actual usage of each document by individuals and groups within the defined organization.

### BACKGROUND OF THE DISCLOSURE

This application is based on a provisional application No. 60/520,686, filed Nov. 17, 2003.

The present invention relates to records management systems and, more particularly to a record or document management system that monitors and tracks document usage history in relation to the users' organizational structures.

Businesses and institutions such as those in Government, healthcare service, financial service, legal service, and the like, each has a structured organization, and are constantly generating, storing and using an ever increasing volume of records or documents, which today are more and more electronic in form. Such records or documents must be managed properly in order to derive their full value. Such management is usually in accordance with legal, and a record retention program, requirements. The entire process usually is costly.

Within each business or institution, proper records management may include decisions as to which records or documents to continue to generate, which to store on-site or off-site, which to discontinue, which to destroy, which to retain beyond the normal retention program guidelines. There may be further interest and value in keeping track of which individuals and job positions within groups or departments of an organization are accessing which documents and in what manner?

There is therefore a need for a record or document management system that monitors and tracks document usage history in relation to the users' organizational structure.

In accordance with the present disclosure, there is provided a document repository management system for an institution having a defined organization. The document repository management system has (a) a first database containing organizational chart information including information identifying individuals in the defined organization, (b) a second database containing accessible documents, (c) programs for controlling requested access to each document of the accessible documents in the second database, and (d) programs for mapping, to the organizational chart information of the first database, each requested access to each document of the accessible documents, thereby enabling efficient management of the document repository based on historical tracking of actual usage of each document by individuals and groups within the defined organization.

In the detailed description of the disclosure presented below, reference is made to the drawings, in which:

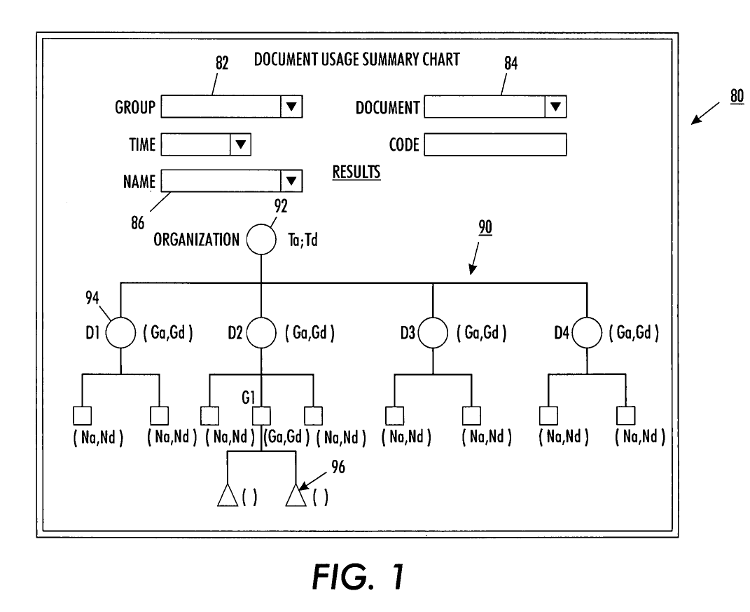

FIG. 1 is an is illustration of a document usage summary chart for a defined organization showing department level, group level and individual usage data;

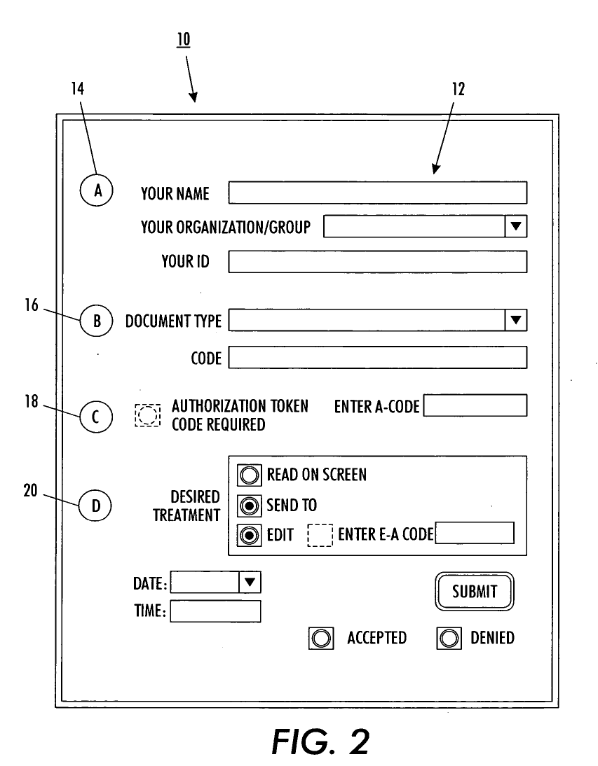

FIG. 2 is an exemplary document access request form;

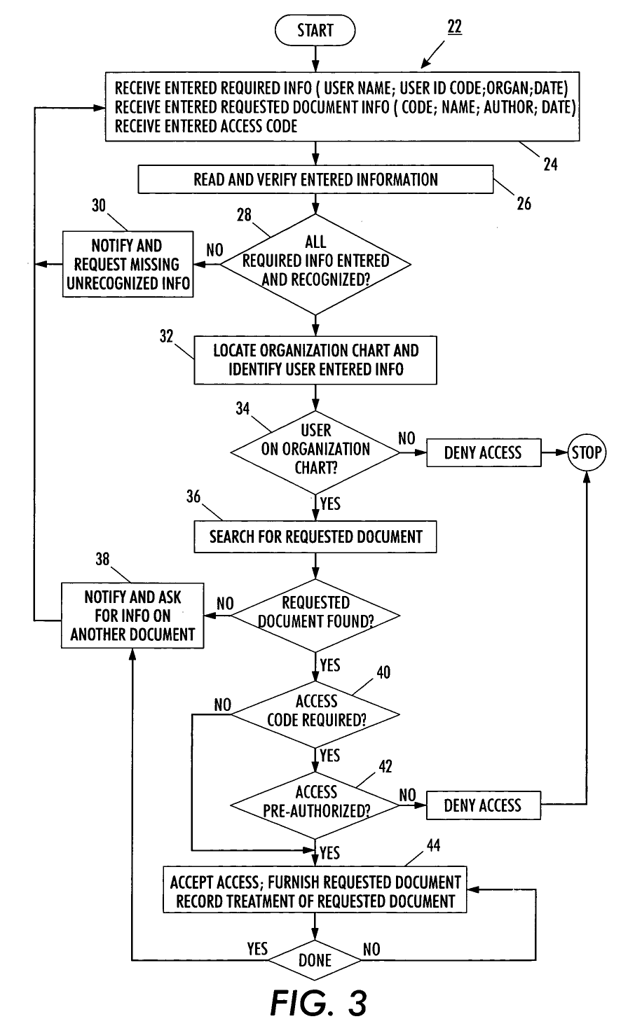

FIG. 3 is a flow chart of the method of the document repository management system; and

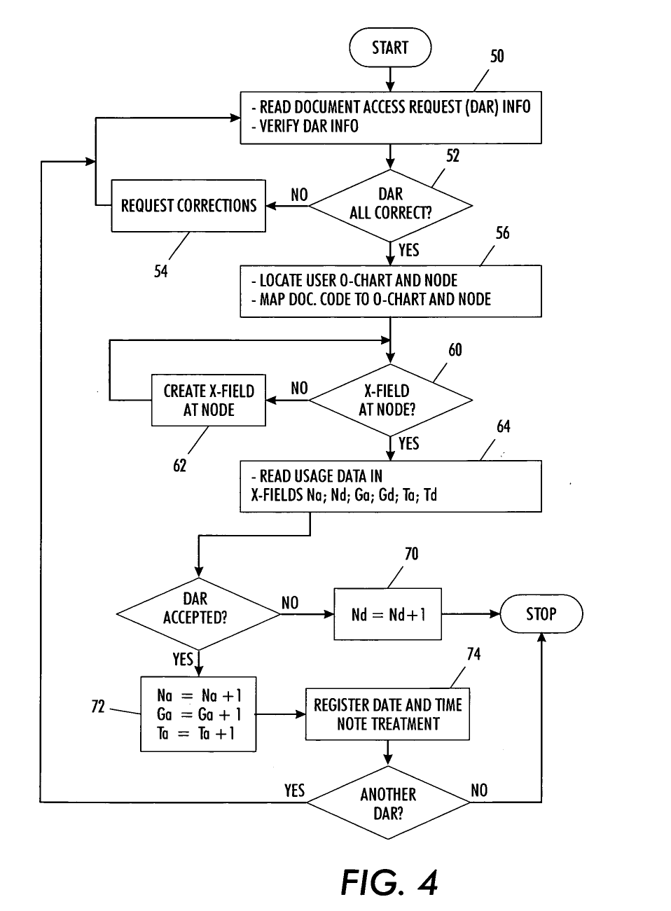

FIG. 4 is a flow chart of the document usage mapping aspect in accordance with the present disclosure.

### DETAILED DESCRIPTION OF THE DISCLOSURE

While the present disclosure will be described in connection with a preferred embodiment thereof, it will be understood that it is not intended to limit the disclosure to that embodiment. On the contrary, it is intended to cover all alternatives, modifications, and equivalents as may be included within the spirit and scope of the disclosure as defined by the appended claims. Referring first to FIG. 2, there is illustrated an exemplary document access request (DAR) form, such as an electronic form, 10 on which an individual wishing to access a particular document is required to input information 12. As illustrated, the DAR form 10 includes a personal information section 14 for inputting information about the person seeking access, a document information 16 for inputting information about the particular document being accessed. The DAR form 10 also includes an authorization section 18 for inputting access authorization information if needed, a desired treatment selection section 20 for selecting one or more of repository authorized treatments of the particular document, and a final section for recording the date and time for submission and processing of the request, as well as the outcome of the request.

As shown and labeled, the personal information section 14 includes a name field, and organization or group field, and a personal ID or identification code field. The document information section 16 includes a document name or other text descriptor field and a document code field where the requestor for example knows the document code or number. As further illustrated, the authorization section 18 is an optional filed, and information therefor is required only in the case of certain documents. The document treatment section 20, for example includes a “read on screen”, a “send to” and a pre-authorized “edit” treatment options. When all necessary access request information for a particular document has been entered, it is then submitted for processing, and the date and time is noted. The system then notifies the requestor whether the request is accepted or denied. If accept, the document will be produced for opening and treatment per the request terms.

Referring next to FIG. 3, there is illustrated a flow chart 22 of the method of the document repository management system of the present disclosure. As illustrated and labeled, a system controller (not shown) but as is well known, receives, reads and verifies (at 24-30) the information inputted on the DAR form 10 as above, and requests re-input of missing or unrecognizable information. When all the required input information is recognized, the system at 32 locates a defined organization chart for the institution and locates the requester, his group, position and title on the organization chart. If as shown at 34 the requestor is not on the organization chart, the document access request is of course denied and the system records the transaction and stops.

If the requestor is on the organization chart, then the system at 36 seeks the requested document and notifies the requester at 38 if it is not found. If it is found, then an access authorization code must be provided at 40-42 if one is required, or else the access request is denied. If not required, the access request is accepted, the document is furnished and the transaction including the treatment is recorded at 44. Access will be denied where an access authorization code is required but none is provided.

Document usage and treatment history on the institution's organization chart is illustrated for example in FIGS. 4 and 1. As shown at 50-54, upon receiving and verifying the requestor information as above, the system at 56 locates the organization chart (O-chart) and maps the request transaction to the document code (DOC. Code) and to the particular position or (Node) on the O-chart where the requestor is located. The position and title of the Node and person are recorded. The system at 60-64 then examines the particular Node for a data field (X-field) for recording usage data, including the current data, about the particular document. If no such field exist, then the system creates one for example at 96 (FIG. 1). If the field already exists, it should have for example at least two types of data, for example Na (for number of times a request for that particular document has been accepted), and Nd (for number of times a request for that particular document has been denied).

If the Node is a group level Node, such as 94 (FIG. 1), then the data field will include Ga data (for number of times request for that particular document have been accepted for members of that group), Gd (for number of times requests by members of that group for that particular document have been denied). This pattern of course is repeated at every group or department level until at 92 Ta and Td data (for number of times requests for that particular document by all members of the institution have been accepted or denied respectively).

As shown in FIG. 1, the two types of data can be displayed side by side as illustrated on a document usage summary chart 80 resembling the institution's organization chart. As illustrated, the summary chart 80 has options for selecting the data to be displayed by group at 82, document type or code at 84 or b an individuals name at 86. The data display can be textual, or graphic as illustrated at 90.

The displayable data Na, Nd, Ga, Gd and Ta, Td is updated as illustrated in FIG. 4 at 70-74 for each document access request processed by the system.

The system of the present invention thus is directed to an automated creation of a document usage history that is mapped to the organization chart of an institution. Data for such document usage is collected automatically from document access logs of the repository. As described above, a log is kept of all the access requests for the documents each individual on the institutions' organization wishes to track. The access request information includes the requestor ID of the individual, as well as the date and time of the access request. Conventional document repositories keep such logs, however, access requests can be anonymous and in particular are not tied to the institutions' organization. Other, ad hoc systems of document distribution (FTP servers, individual web pages) also keep such logs, however they often don't have any ID authentication requirements. Mapping the document access and treatment as above to the institutions' organization chart can enable and empower the repository and institution management to make very informed and precise decisions on how to label or treat particular documents in the depository.

The system of course requires the organization chart to be in an electronically readable form. As such, it can be in any suitable format (LDAP directory, Exchange server mailing lists, etc.) as long as a controller program can understand and work with it. One important requirement is that the requestor's information including ID found in the access log must be directly mapable to the individual's node or position on the electronic organization chart.

The mapping can be generated as part of a document repository interface, or it can be generated by an independent program. The results of the mapped and accumulated data can take several forms, for example, they can be in the form of a variety of textual reports. These can include high level reports giving the overall usage, medium level reports giving usage for every organization, and low level reports detailing each access for each group or department.

Since an organization chart is naturally graphical in nature (a hierarchical series of boxes), it naturally lends itself to an interactive graphical mapping as shown in FIG. 1. Thus given a particular document, an organization chart can display the number of accesses numerically as a number, or graphically as the size of a box or bar (the more accesses, the larger the box or bar). Different types of data can be color coded for differentiation.

Thus according to the present invention, the document repository management (DRM) system for an institution having a defined organization, includes (a) a first database containing organizational chart information including information identifying individuals on the defined organization, and (b) a second database containing accessible documents. The (DRM) system also includes a controller and programs for controlling requested access to each document in the second database, as well as for mapping, to the organizational chart information of the first database, each requested access to the each document. This thereby enables efficient management of the document repository based on historical tracking of actual usage and treatment of each document by individuals and groups within the defined organization.

The organizational chart information at 14 (FIG. 2) and at 82, 86 includes data for forming the graphical chart 80 (FIG. 1) of the defined organization, and for identifying departments, and groups within each department of the defined organization. It may also include information identifying a geographical location for each department or group unit within the defined organization. Importantly, it includes information identifying a title for each individual of the individuals within the defined organization.

The second database at 16 (FIG. 2) and at 84 (FIG. 1) includes metadata (that is data descriptive of each document) on each document of the accessible documents. Such metadata may include document title information, document code information, document authorship information, date of authorship information, and information on date of document reposition.

As illustrated in FIGS. 2 and 3, the programs for controlling access to each document of the accessible documents include a pre-authorization code at 18 for each individual based on membership in the defined organization, based on reporting positions within the defined organization, as well as based on departments, and groups within departments in the defined organization. They also include a pre-authorization code for each individual based on permitted possible treatments of each accessible document.

The programs for mapping document access request to the defined organization chart include routines for identifying, summarizing and tracking each requested access in terms of a name of a pre-authorized individual in the defined organization, as part of a count of all requested accesses for the particular document within each group of individuals in each department, and within each department within the defined organization. They may also include routines for identifying, summarizing and tracking each requested access in terms of locations identified within the organizational chart information of the defined organization, and in terms of positions and titles within the defined organization.

The document repository management system as shown in 80 and 90 (FIG. 1) includes capability for displaying graphically or otherwise an organizational chart of the defined organization, and data on requested accesses for each document of the accessible documents. The graphical chart as shown includes different organizational levels such as department levels D1-D4 (FIG. 1) and group levels with each such department level. It may also include title information for each department and group leader position.

In accordance with the present invention, a method of managing documents and records in a document repository of an institution having a defined organization includes (i) maintaining a first database containing organizational chart information including information identifying individuals on the defined organization; (ii) maintaining a second database containing accessible documents; (iii) controlling requested access to each document of the accessible documents in the second database; and (iv) mapping, to the organizational chart information, each the requested access to the each document of the accessible documents, thereby enabling efficient management of the document repository based on historical tracking of actual usage and treatment of each document by individuals and groups within the defined organization.

Maintaining the first database includes for example periodically updating the organizational chart information to reflect changes in any location, position and title information on individuals within the defined organization, and maintaining the second database includes adding and subtracting documents and editing documents and document metadata. Maintaining the second database also includes periodically updating document access pre-authorization based on changes in any location, position and title of individuals within the defined organization.

As can be seen, there has been provided a document repository management system for an institution having a defined organization. The document repository management system has (a) a first database containing organizational chart information including information identifying individuals in the defined organization, (b) a second database containing accessible documents, (c) programs for controlling requested access to each document of the accessible documents in the second database, and (d) programs for mapping, to the organizational chart information of the first database, each requested access to each document of the accessible documents, thereby enabling efficient management of the document repository based on historical tracking of actual usage of each document by individuals and groups within the defined organization.

While the embodiment of the present disclosure disclosed herein is preferred, it will be appreciated from this teaching that various alternative, modifications, variations or improvements therein may be made by those skilled in the art, which are intended to be encompassed by the following claims:

1. A document repository management (DRM) system for an institution having a defined organization, the DRM system comprising:
(a) a first database containing organizational chart information including information identifying individuals on said defined organization;
(b) a second database containing accessible documents;
(c) means for controlling requested access to each document of said accessible documents in said second database; and
(d) means for mapping, to said organizational chart information of said first database, each said requested access to said each document of said accessible documents, thereby enabling efficient management of the document repository based on historical tracking of actual usage and treatment of each document by individuals and groups within the defined organization.

2. The DRM System of claim 1, wherein said organizational chart information includes data for forming a graphical chart of said defined organization.

3. The DRM System of claim 1, wherein said organizational chart information includes information identifying departments within said defined organization.

4. The DRM System of claim 1, wherein said organizational chart information includes information identifying departments within said defined organization, and groups within each department of said departments.

5. The DRM System of claim 1, wherein said organizational chart information includes information identifying a geographical location for each unit within said defined organization.

6. The DRM System of claim 1, wherein said organizational chart information includes information identifying a title for each individual of said individuals within said defined organization.

7. The DRM System of claim 1, wherein said second database includes metadata on each document of said accessible documents.

8. The DRM System of claim 1, wherein said means for controlling access to each document of said accessible documents includes a pre-authorization code for each individual based on membership in said defined organization.

9. The DRM System of claim 1, wherein said means for controlling access to each of said accessible documents includes a pre-authorization code for each individual based on reporting positions within said defined organization.

10. The DRM System of claim 1, wherein said means for controlling access to each of said accessible documents includes a pre-authorization code for each individual on a basis of departments within said defined organizations.

11. The DRM System of claim 1, wherein said means for controlling access to each of said accessible documents includes a pre-authorization code for each individual on a basis of groups within departments in said defined organization.

12. The DRM System of claim 1, wherein said means for controlling access to each of said accessible documents includes a pre-authorization code for each individual based on permitted possible treatments of each said accessible document.

13. The DRM System of claim 1, wherein said means for mapping includes means for identifying, summarizing and tracking each said requested access in terms of a name of a pre-authorized individual in said defined organization.

14. The DRM System of claim 1, wherein said means for mapping includes means for identifying, summarizing and tracking each said requested access for a particular document as part of a count of all requested accesses for said particular document within each group of individuals in each department in said defined organization.

15. The DRM System of claim 1, wherein said means for mapping includes means for identifying, summarizing and tracking each said requested access for a particular document as part of a count of all requested accesses for said particular document within each department within said defined organization.

16. The DRM System of claim 1, wherein said means for mapping includes means for identifying, summarizing and tracking each said requested access in terms of locations identified within said organizational chart information of said defined organization.

17. The DRM System of claim 1, wherein said means for mapping includes means for identifying, summarizing and tracking each said requested access in terms of positions and titles within said defined organization.

18. The DRM System of claim 1, including means for displaying an organizational chart of said defined organization, and data on requested accesses for said each document of said accessible documents.

19. The DRM System of claim 2, wherein said graphical chart includes organizational levels including department levels, group levels within said department levels, and an individuals level.

20. The DRM System of claim 2, wherein said graphical chart data includes title information for each department and group leader position.

21. The DRM System of claim 7, wherein said metadata includes document title information.

22. The DRM System of claim 7, wherein said metadata includes document code information.

23. The DRM System of claim 7, wherein said metadata includes document authorship information.

24. The DRM System of claim 7, wherein said metadata includes date of authorship information.

25. The DRM System of claim 7, wherein said metadata includes information on date of document reposition.

26. The DRM System of claim 19, wherein said graphical chart includes at each department and each group level two types of data.

27. A method of managing documents and records in a document repository of an institution having a defined organization, the method comprising:
(i) maintaining a first database containing organizational chart information including information identifying individuals on said defined organization;
(ii) maintaining a second database containing accessible documents;
(iii) controlling requested access to each document of said accessible documents in said second database; and
(iv) mapping, to said organizational chart information, each said requested access to said each document of said accessible documents, thereby enabling efficient management of the document repository based on historical tracking of actual usage and treatment of each document by individuals and groups within the defined organization.

28. The method of claim 27, wherein maintaining said first database includes periodically updating said organizational chart information to reflect changes in any location, position and title information on individuals within said defined organization.

29. The method of claim 27, wherein maintaining said second database includes adding and subtracting documents and editing documents and document metadata.

30. The method of claim 27, wherein maintaining said second database includes periodically updating document access pre-authorization based on changes in any location, position and title of individuals within said defined organization.
